(19) United States
(12) Patent Application Publication
(10) Pub. No.: US 2011/0052904 A1
(43) Pub. Date: Mar. 3, 2011

(54) PULTRUSION PROCESS AND RELATED ARTICLE

(75) Inventor: Joseph A. GUARRIELLO, Freeland, MD (US)

(73) Assignee: GRAHAM ENGINEERING CORPORATION, York, PA (US)

(21) Appl. No.: 12/870,280

(22) Filed: Aug. 27, 2010

Related U.S. Application Data
(60) Provisional application No. 61/237,963, filed on Aug. 28, 2009.

(51) Int. Cl. B32B 5/28; B29C 70/66

(52) U.S. Cl. 428/319.3; 264/35

(57) ABSTRACT

A pultrusion article and method for manufacturing the same is disclosed. The article has a core of cured thermoset material and foaming agent. Unidirectional fibers are distributed about the periphery of the article. A shell of cured thermoset material encapsulates the unidirectional fibers, with the shell having a greater density than the core. The core and the shell are bonded together. The article provides increased strength without the use of cross-fibers.

### FIELD OF THE INVENTION

This invention relates generally to continuous profile molding methods and products made using such methods. More particularly, the present invention relates to processes for manufacturing pultrusion articles that may be used, for example, as tool handles, having a construction which significantly increases the strength of such articles without a significant corresponding increase in weight.

### BACKGROUND OF THE INVENTION

The process of pultrusion generally involves the manufacture of articles having a continuous profile of a single selected cross-section matching that of a die. Usually the manufactured article comprises a thermosetting type resin (i.e., polyesters, epoxies, phenolics, etc.), reinforced with such materials as reinforcing fibers, including boron, Kevlar, hemp, cotton, sisal, etc. Pultrusion manufacturing processes have a significant number of applications, but there is also a significant limitation, i.e., the articles produced have only one continuous profile (round, square, hollow, channel, etc.) in cross-section.

In recent years, pultrusion manufacturing processes have been adapted to manufacture composite rod assemblies that may be used as handles for hand tools such as shovels, rakes, hoes and the like. The basic technique for running filaments through a resin bath and then through an elongated heated die chamber to produce a cured composite rod of the same shape as the die chamber has been known for some time. See, for example, U.S. Pat. Nos. 2,948,649 and 3,556,888. This method, however, produces a solid extruded product which is unacceptably heavy and/or too rigid for many tool handle applications. The weight problem can be alleviated by means of an existing process to extrude hollow chambers utilizing a die chamber with the center filled, leaving an annular cross-section through which the resin-coated fibers are pulled. This weight reduction is achieved, however, at the cost of significantly reduced bending or flexural strength in comparison with a solid rod, resulting in a tool handle which would not be suitable for use in certain high-stress applications such as general purpose shovel handles. Further, to increase interlaminar strength of the chamber-forming fibers, a substantial percentage of fibers running other than in a longitudinal direction have been thought to be required.

In an attempt to improve the bending strength of tool handles, the fiber-resin rods, which are manufactured to be substantially hollow throughout a major portion of their length, have been reinforced at areas of expected high stresses during tool use. Such improved tool handles and related methods are shown in U.S. Pat. No. 4,570,988. These composite tool handles have further been improved by the introduction of one or more reinforcing beads of fiber-resin material extending the length of the load-bearing rod. Such tool handles are shown in U.S. Pat. No. 4,605,254, the contents of which are incorporated herein by reference.

Although such above-described composite tool handles are generally superior to wooden handles, the competitive pressures of the marketplace have encouraged tool handle manufacturers to seek new processes, materials and construction techniques to further increase the strength of composite tool handles.

It is well known that utilizing unidirectional strands of resin-coated glass fibers in a pultrusion process is the most economical process for manufacturing a composite rod assembly. In many cases, glass fibers such as a fabric mat veil have been introduced into the pultrusion process to reduce interlaminar failure or to increase the hoop strength of the rod assembly by providing cross-fibers within the cured fiber-resin composite load-bearing jacket. The use of cross-fibers, however, typically and undesirably increases the costs associated with manufacture of composite rod assemblies and decreases tensile strength along the length thereof.

Composite rod assemblies are far stronger in tension (due to the strength characteristics of the fiber materials), whereas the compressive loads are borne almost entirely by the interfiber resinous material.

Accordingly, there has been an on-going need for improved composite assemblies and related manufacturing processes to provide significantly increased tensile and flexural strength without a corresponding increase in weight. Such a manufacturing process preferably permits use of relatively low-cost fiber and resin materials, and utilizes unidirectional fibers in a pultrusion manufacturing process. Additionally, there exists a need for a composite assembly having increased interlaminar and hoop strength without the use of cross-fibers. Moreover, a novel composite assembly is needed which has greatly-improved resistance to shear failure through the resin, as exhibited in prior composite rod assemblies. The present invention fulfills these needs and provides other related advantages.

### SUMMARY OF THE INVENTION

The present invention resides in an improved process for manufacturing pultrusion articles that may be used, for example, as a tool handle, and a pultrusion die molding process for making such articles. The manufacturing process comprises, generally: feeding fibers into a pultrusion die, such that the fibers are aligned about the periphery of the die chamber; injecting thermoset material and a foaming agent into the die, such that the thermoset material and the foaming agent are mixed, distributing the thermoset material and foaming agent such that a solid skin is formed about the fibers and a foamed core is formed therebetween; and advancing the fibers and the core through the die to allow the article to cure, such that a reinforced skin, which has increased tensile strength, is bonded to the core, which has increased compressive strength.

An object of the invention is to provide a continuous article which can be quickly and easily manufactured with a foamed, lightweight, crush-proof core and a reinforced shell.

Another object is to provide a trouble-free and reliable method which is more economical than existing alternatives, and the end product of this invention is relatively strong due to the strong tensile strength of the shell and the strong compressive strength of the core.

Another object is to provide an article the strength of which is enhanced by the perfect molded fit and strong bonding of the shell to the core.

Another object is to provide a method for producing a pultruded article which utilizes a foaming agent to allow for uniform cells to form, with a good structure to provide for increased strength and reduced weight of the core.

Another object is to provide an article with increased tensile and flexural strength without a corresponding increase in weight by using unidirectional fibers in a pultrusion manufacturing process.

Another object is to provide an article with increased interlaminate and hoop strength without the use of cross fibers.

Another object is to provide an article with improved resistance to shear failure through the thermoset material.

One aspect of the invention is directed to a method for manufacturing a pultrusion article. The method includes: pulling fibers through a die chamber, with the fibers being distributed about the periphery of the die chamber; injecting thermoset material and a foaming agent into the die chamber; and distributing the thermoset material and foaming agent through the die chamber, whereby the thermoset material and foaming agent cooperate with the fibers about the periphery of the die chamber to form a shell about an inner core of thermoset material and foaming agent.

Another aspect of the invention is directed to an article having a core of cured thermoset material and foaming agent. Unidirectional fibers are distributed about the periphery of the article. A shell of cured thermoset material encapsulates the unidirectional fibers, with the shell having a greater density than the core. The core and the shell are bonded together.

Another aspect of the invention is directed to a pultruded article having a core and a shell. The core is of cured thermoset material and foaming agent. The shell is of cured thermoset material encapsulating pultruded unidirectional fibers. The pultruded article provides increased strength without the use of cross-fibers.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

FIG. 1 is a schematic representation of the pultrusion machine adapted to perform the process described herein.

FIG. 2 is an enlarged view of a portion of the machine, showing a mandrel and die chamber with fibers and thermoset resin positioned therein.

FIG. 3 is a cross-section view of one embodiment of an article which is manufactured using the process described herein.

FIG. 4 is a cross-section view of a second embodiment of an article which is manufactured using the process described herein.

FIG. 5 is a perspective view of a shovel having a handle manufactured in accordance with the method described.

### DETAILED DESCRIPTION

As shown in the exemplary drawings, the present invention is embodied in a composite fiber-resin article 10 with foamed core 12, and a pultrusion process or method for its production. However, the invention is not limited to a composite fiber-resin rod. The process described herein can be used to manufacture many different articles, including articles with cross-sectional shapes which are not round or uniform and articles which have a relatively large cross-sectional area or articles which have a relatively long length.

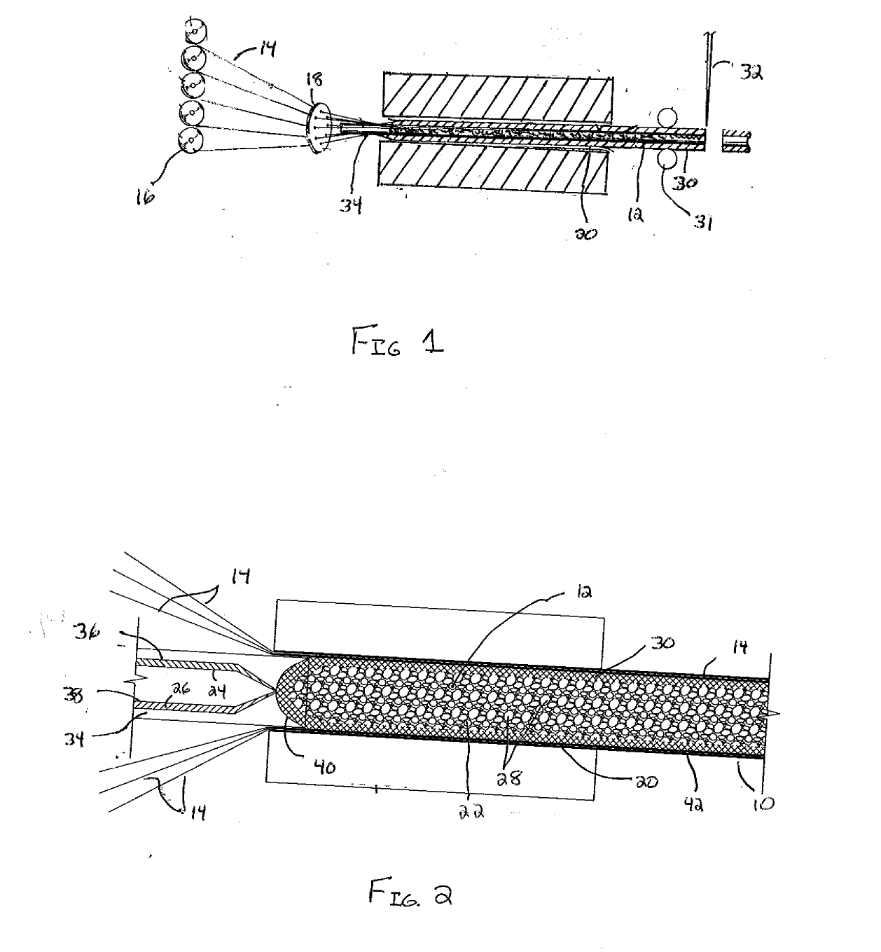

In exemplary FIG. 1, the method of this invention is schematically illustrated. A fiber material 14 is drawn off of a series of spools 16 or bales and through a carding disc 18 into a die chamber 20. Alternatively, fiber mats (not shown) may be drawn into the die chamber 20. A thermoset material or resin mixture 22 is introduced into the die chamber 20 proximate a first end thereof. The thermoset resin 22 may be of the type in which an exothermic reaction occurs when the components 24, 26 of the thermoset resin 22 are mixed together. The thermoset resin includes a foaming agent therein which allows the resin to foam or expand to create the foamed core 12 with air gap 28 and a solid skin 30 on the outside of the article being formed (adjacent the surface of the die chamber), the article being reinforced with the fibers 14. For particular applications, the thermoset resin may have fillers provided therein, such as, but not limited to, wood flour and calcium carbonate. The fibers 14 are pulled through the die chamber 20, causing the thermoset resin 22 to coat the fibers 14. If a sufficient exothermic reaction occurs, sufficient heat may be generated to allow the thermoset material 22 to cure and bond to the fibers 14 as the fibers 14 are pulled through the die chamber 20. Additional heat, if required, may be supplied by a heating element (not shown) which surrounds the die chamber 20. If the exothermic reaction generates too much heat, cooling may be supplied by a cooling element (not shown) which surrounds the die chamber 20. In any case, the die chamber 20 is configured so that as the article is pulled out of the die chamber 20, by tractor type pullers 31 or other known devices, the article is fully cured. The fully cured article may then be cut into the desired length by a conventional cutting device 32 or have additional coatings applied thereto in other stations.

As better shown in FIG. 2, the fibers 14 are inserted into the die chamber 20 around the periphery thereof. The fibers 14 may be fiberglass or any other material that has the desired physical and tensile strength characteristics desired. A die insert or mandrel 34 is positioned proximate a first end of the die chamber 20 and extends partially therein. The mandrel 34 is dimensioned to have a cross-sectional shape which is similar to, but smaller than, the cross-sectional shape of the die chamber 20. This allows the fibers 14 to be inserted into the die chamber 20 around the periphery thereof. The mandrel 34 has two delivery chambers 36, 38 which extend therethrough. In the embodiment shown, the two delivery chambers 36, 38 extend from one end toward a second end. Portions of the first delivery chamber 36 and the second delivery chamber 38 are essentially parallel to each other. Proximate the second end of the mandrel 34, the two chambers 36, 38 converge. The particular configuration of the delivery chambers 36, 38 and their relative position to each other can vary without departing from the scope of the invention. The second end of the mandrel 34 has a concave arcuate portion 40. The delivery chambers 36, 38 extend through the second end such that the convergence of the two chambers 36, 38 occurs proximate the center of the concave arcuate portion 40.

As is shown in the Figures, the two delivery chambers 34, 36 are used to deliver the components 24, 26 of thermoset resin 22 or mixture to the die chamber 20. The thermoset resin 22 may be a polyurethane base or any other material having the desired compressive strength, physical and curing characteristics required. A first component 24 of the thermoset resin 22 may be introduced into a mixing chamber (not shown) prior to entering either of the delivery chambers. A second component 26 or hardener may be supplied to the mixing chamber. In addition, a foaming agent may be introduced into the mixing chamber. The mixture of the first component 24, second component 26 and foaming agent is introduced into the delivery chambers and flows through the delivery chambers to the die chamber 20. In this embodiment, the mixing chamber must be provided in close proximity to the die chamber, so that the mixture can be supplied through the delivery chambers before the chemical reaction caused by mixing the components increases viscosity and inhibits the movement of the mixture through the delivery chambers. Also in this embodiment, the delivery chambers need not converge prior to entering the die chamber 20 and, therefore, may be spaced at different locations along the concave portion 40 of the die chamber 20.

Alternatively, as shown in FIG. 2, the first component 24 of the thermoset resin 22 may flow through one of the delivery chambers 36, and the second component 26 may flow through the alternate delivery chamber 38. In this embodiment, the first component 24 and the second component 26 do not mix until they are introduced into the die chamber 20. The foaming agent may be introduced into either the first component 24 or the second component 26 prior to the introduction of either into the respective delivery chamber 20. This allows the chemical reaction caused when the components 24, 26 are mixed together to be properly controlled in the die chamber 20. In this embodiment, the first and second components 24, 26 are forced through the delivery chambers 36, 38 under high pressure. The high pressure causes the first and second components 24, 26 to properly mix in the die chamber 20 as they exit the delivery chambers 36, 38. This method is sometimes referred to as impingement mixing.

In another alternative, the first component 24 of the thermoset resin 22 may flow through one of the delivery chambers 36, and the second component 26 may flow through the alternate delivery chamber 38. In this embodiment, the delivery chambers 36, 38 converge into a mixing chamber (not shown) before they reach the second end of the mandrel 34. This allows the first component 24 and the second component 26 to mix immediately prior to being introduced into the die chamber 20. The foaming agent may be introduced into either the first component 24 or the second component 26 prior to the introduction of either into the respective delivery chamber 36, 38. This allows the chemical reaction caused when the components 24, 26 are mixed together to be properly controlled in the mixing chamber of the mandrel 34. A static mixer (not shown) may be provided in the mixing chamber to facilitate the proper mixing of the components 22, 24 in the mixing chamber. The mixed components are then introduced into the die chamber 20. The components 24, 26 may be forced through the delivery chambers at a relatively low pressure, as the configuration of the mixing chamber facilitates the proper mixing of the components 24, 26 prior to their introduction into the die chamber 20.

The term “foaming agent” is used to describe any substance which, alone or in combination with other substances, is capable of producing a cellular structure in a plastic or rubber mass. Thus, foaming agents include soluble solids that leave pores when pressure is released, soluble solids that leave pores when leached out, liquids which develop cells when they change to gases, and chemical agents that decompose or react under the influence of heat to form a gas. An endothermic foaming agent is a foaming agent that absorbs heat, and an exothermic foaming agent is a foaming agent that generates heat. While an exothermic foaming agent is described herein, the invention is not limited to the use of an exothermic foaming agent. A number of foaming agents suitable for use in the method described herein are described below. In no way should the description of these foaming agents be construed as limiting the scope of the invention. Any foaming agent having the appropriate properties is suitable.

Solid foaming agents are typically employed in pellet form. The actual foaming agent may dust a carrier pellet, such as a low-density polyethylene bead. Liquid foaming agents are generally employed in a carrier, such as a fatty acid ester, a mineral oil or a polyol. Known liquid foaming agents include certain aliphatic and halogenated hydrocarbons, low boiling alcohols, ethers, ketones, and aromatic hydrocarbons. Chemical foaming agents range from simple salts such as ammonium or sodium bicarbonate to complex nitrogen-releasing agents, of which azobisformamide is an important example.

Foaming agents are generally classified as physical or chemical. Chemical foaming agents undergo a chemical transformation when producing gas, while physical foaming agents undergo a generally reversible physical change of state, e.g., vaporization. Physical foaming agents include liquid agents. Liquid physical foaming agents include volatile liquids which produce gas through vaporization. Chemical foaming agents are generally solids that liberate gas(es) by means of a chemical reaction or decomposition when heated. They are necessarily selected for specific applications or processes based on their decomposition temperatures.

As described above, the foaming agent is added to the thermoset mixture. Typically, foaming agents are added in an amount greater than 0 to about 5 percent by volume of the thermoset mixture.

In operation, the fibers 14 are continuously pulled into the die chamber 20 about the periphery thereof. As previously described, the thermoset resin mixture 22 with the foaming agent is caused to flow into the die chamber 20. The rate at which the mixture flows into the die chamber 20 is governed based on the speed at which the fibers 14 are pulled through the die chamber 20 and the desired density required for the core 12. The concave arcuate portion 40 of the mandrel 34 is configured to insure that the thermoset resin mixture is properly mixed as the components 24, 26 exit the delivery chambers 36, 38. The configuration of the concave arcuate portion 40 of the mandrel 34 also facilitates the delivery of the thermoset resin 22 mixture to coat the fibers 14, as a portion of the thermoset resin mixture 22 will flow along the surface of the concave arcuate portion 40 and be deposited on the fibers 14.

As the thermoset resin mixture 22 is continually fed into the die chamber 20, the mixture 22 is continually advanced along the longitudinal axis of the die chamber 20, in a direction away from the mandrel 34. Simultaneously, the fibers 14 are pulled through the die chamber 20 using conventional pultrusion techniques. As this occurs, the fibers 14 and thermoset resin mixture 22 are heated, by heat generated by the exothermic reaction, by a conventional heating element which surrounds the die chamber 20, or both, to accelerate the curing of the thermoset resin mixture. The cured article is pulled from the die chamber 20 by tractor-type pullers 31, or other known means, and cut to length using known cutting devices 32. Prior to or after cutting, the article may be subjected to additional operations, such as co-extruding a cap stock layer, injection molding, coating or other such operations, to provide enhanced features based on the use of the article.

As described, the core 12 is foamed using a foaming agent to create the foam core before the core solidifies. The pressure created from the foaming agent causes the foamed material to flow toward the periphery of the die chamber 20. As the material flows outward, the walls of the die chamber 20 prevent or constrain the further flow of material beyond the walls. Due to the constrained flow of the foamed material at the periphery, the material is compressed, minimizing the effect of the foaming agent, and thereby forming a solid skin 30 on the outside of the article. As the fibers 14 are positioned about the periphery of the die chamber 20, the solid skin 30 forms about the fibers 14. This causes the fibers 14 to reinforce the solid skin 30, thereby providing extra strength to the shell 42 of the article. The thickness of the skin 30 of the foamed material can be controlled by the speed at which the thermoset material 22 is introduced into the die chamber 20, by the speed at which the fibers 14 are pulled through the die chamber 20, and/or by the amount of foaming agent 28 introduced into the thermoset material 22. By allowing the thermoset material 22 to advance more slowly or by using a greater proportion of foaming agent to thermoset resin, the pressure developed in the core 12 will cause more material to be pushed toward the periphery, causing the skin 30 to become thicker. These same factors also affect the density and compressive strength of the core 12. The more thermoset resin 22 that is pushed to the periphery, the less thermoset resin remains in the core 12, causing the density of the core 12 to be reduced. However, due to the foaming agent and the resulting air voids 28, the compressive strength of the core 12 is increased.

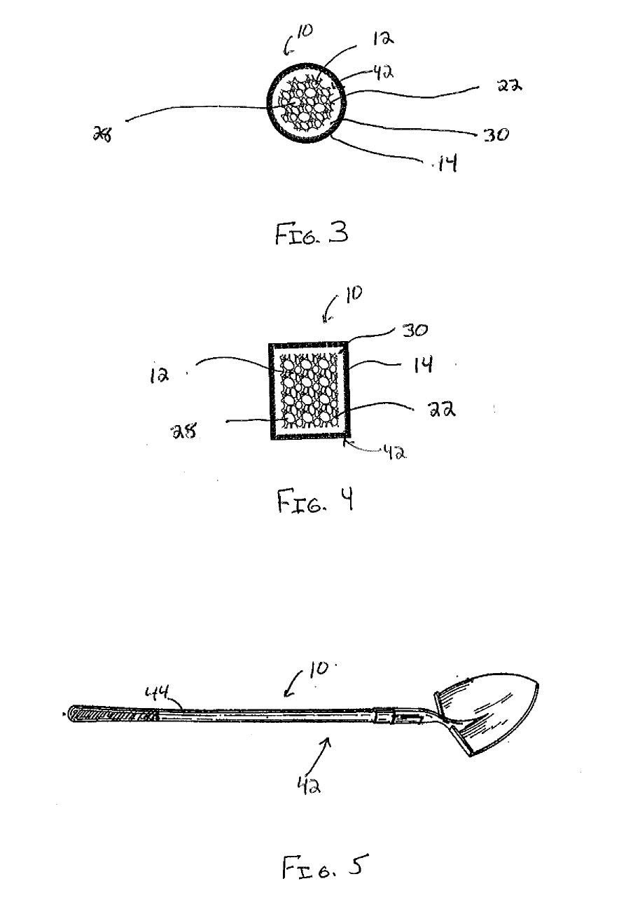

Examples of articles manufactured by the process are shown in FIGS. 3, 4 and 5. FIG. 3 is a cross-sectional view illustrating a portion of the essentially round article, showing the fiber-resin composite shell 42 bonded to the foamed core 12. FIG. 4 is a cross-sectional view illustrating a portion of the essentially rectangular article, showing the fiber-resin composite shell 42 bonded to the foamed core 12. In each illustration, the air voids 28 are shown in the foamed core 12. FIG. 5 is a perspective view of a shovel 44 having a handle 46 manufactured in accordance with the method described. FIGS. 3, 4 and 5 are shown as representative examples and are not meant to limit the scope of the invention to these particular embodiments.

By this method, a continuous article 10 can be quickly and easily manufactured with a foamed, lightweight, crush-proof core 12 and a reinforced shell 42. The method of this invention is trouble-free and reliable in use, is more economical than existing alternatives, and the end product of this invention is relatively strong due to the strong tensile strength of the shell and the strong compressive strength of the core. The strength is enhanced by the perfect molded fit and strong bonding of the shell 42 to the core 12.

The use of the foaming agent allows for uniform cells to form, with a good structure. This provides for increased strength and reduced weight of the core 12. The use of the foaming agent also produces a repeatable and consistent structure, as the foaming agent is uniformly activated through the core.

Foaming agents also tend to remain homogenized when added to the thermoset mixture. Using exothermic foaming agents also allows for faster production. Since the exothermic foaming agent adds heat, the thermoset mixture can cure more quickly, thereby allowing the fibers and the thermoset mixture to be pulled through the die chamber at a higher rate of speed, such as, for example, at rates of 16 feet/minute.

The use of the foaming agent in the pultrusion process described allows this process to be used for relatively large articles. As the thermoset material cures, the foaming agent expands, negating the thermoset material's tendency to shrink and form voids. This reduces or eliminates the sink marks and other poor aesthetics associated with larger articles having thick cross-sections. This also allows the process to be used with any shape article.

The use of the core 12 and shell 42 described herein provides significantly increased tensile and flexural strength without a corresponding increase in weight. The article uses relatively low-cost fiber and resin materials, and utilizes unidirectional fibers in a pultrusion manufacturing process. This provides an article with increased interlaminate and hoop strength without the use of cross fibers. Additionally, the article has greatly improved resistance to shear failure through the resin, when compared to prior articles.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a pultrusion article, the method comprising:
pulling fibers through a die chamber, the fibers being distributed about the periphery of the die chamber;
injecting thermoset material and a foaming agent into the die chamber;
distributing the thermoset material and foaming agent through the die chamber, whereby the thermoset material and foaming agent cooperate with the fibers about the periphery of the die chamber to form a shell about an inner core of thermoset material and foaming agent.

2. The method as recited in claim 1, wherein the speed at which the fibers are pulled through the die chamber is controlled to control the thickness of the shell.

3. The method as recited in claim 1, wherein the speed at which the thermoset material is introduced into the die chamber is controlled to control the thickness of the shell.

4. The method as recited in claim 1, wherein the amount of foaming agent introduced into the thermoset material is controlled to control the thickness of the shell.

5. The method as recited in claim 1, wherein the thermoset material is injected into the die chamber through a mandrel having an arcuate portion configured to insure that the thermoset material is properly mixed.

6. The method as recited in claim 5, wherein the arcuate portion of the mandrel is concave to facilitate the distribution of the thermoset material to the fibers, whereby a portion of the thermoset material will flow along the surface of the concave arcuate portion and be deposited on the fibers.

7. The method as recited in claim 1, wherein the thermoset material which is injected into the die chamber is mixed in a mixing chamber and then injected into the die chamber through one or more delivery chambers.

8. The method as recited in claim 1, wherein the components of the thermoset material which is injected into the die chamber are injected into the die chamber through multiple delivery chambers, whereby the components are forced through the delivery chambers under high pressure, causing the components to properly mix in the die chamber as they exit the delivery chambers.

9. The method as recited in claim 1, wherein components of the thermoset material which is injected into the die chamber are delivered through multiple delivery chambers to a mixing chamber adjacent the die chamber, allowing the components to mix immediately prior to being introduced into the die chamber, whereby the components may be forced through the delivery chambers at a relatively low pressure, as the configuration of the mixing chamber facilitates the proper mixing of the components prior to their introduction into the die chamber.

10. The method as recited in claim 1, wherein the pressure created from the foaming agent causes the foamed thermoset material to flow toward the periphery of the die chamber forming a solid skin about the periphery, whereby the solid skin and the fibers bond to create the shell and to provide strength to the shell.

11. The method as recited in claim 10, wherein the pressure created from the foaming agent causes the density of the core to be reduced and the compressive strength to be increased.

12. The method as recited in claim 1, wherein the thermoset material is heated by heat generated by the exothermic reaction of the thermoset, thereby accelerating the curing of the thermoset material.

13. The method as recited in claim 1, wherein the thermoset material is heated by a heating element which surrounds the die chamber, thereby accelerating the curing of the thermoset material.

14. An article comprising:
fibers distributed about the periphery of the article;
a core of cured thermoset material and foaming agent;
a shell of cured thermoset material encapsulating the unidirectional fibers, the shell having a greater density than the core;
whereby the core and the shell are bonded together.

15. The article recited in claim 14, wherein the fibers are unidirectional fibers.

16. The article as recited in claim 14, wherein the shell includes a smaller amount of the foaming agent than the core.

17. A pultruded article comprising;
a core of cured thermoset material and foaming agent;
a shell of cured thermoset material encapsulating pultruded unidirectional fibers;
whereby the pultruded article provides increased strength without the use of cross-fibers.

18. The pultruded article as recited in claim 17, wherein the shell includes a smaller amount of the foaming agent than the core.

19. The pultruded article as recited in claim 17, wherein the shell has a greater density of thermoset material than the core.

20. The pultruded article as recited in claim 17, wherein the core and shell are continuously provided over the length of the article.
